(19) United States
(12) Patent Application Publication
(10) Pub. No.: US 2007/0235057 A1
(43) Pub. Date: Oct. 11, 2007

(54) DENTAL FLOSS HOLDER

(76) Inventor: Nickolas Liu, Taipei (TW)

Correspondence Address: CARGILL & ASSOCIATES, P.L.L.C., 56 MACOMB PLACE, MT. CLEMENS, MI, 48043, US

(21) Appl. No.: 11/278,985

(22) Filed: Apr. 7, 2006

(51) Int. Cl. A61C 15/00

(52) U.S. Cl. 132/325

(57) ABSTRACT

A dental floss holder for storing and manipulating dental floss used for cleaning a person's teeth includes a housing, a handle, a spool member, a position mechanism and a scraping member. The housing includes a first case and a second case both being engagable with each other, wherein the first case has an accommodation for accommodating the spool member. The handle communicates with the first case and is cooperatively defined by integrally extending from the first and second case, the handle having a penetrate hole located at one end thereof. A user can draw out the floss through the penetrate hole to a desired length and can manipulate the handle together with the floss for dental cleaning without putting the user's finger to the mouth.

### BACKGROUND OF THE INVENTION

1. Field of the Invention

The present invention relates to devices for storing and manipulating dental floss used for cleaning a person's teeth, particularly to an improved dental floss holder manipulated with mechanical means to clean teeth and can be used repeatedly.

2. Related Art

As is well known, oral hygiene is very important. A basic approach to maintain a well oral hygiene is to brush teeth after every meal. However, it is difficult to brush teeth everywhere after a meal and is not easy to scale the teeth by brushing. Therefore, for the importance of oral hygiene, dentists appeal to everyone to brush teeth cooperatively with picking teeth by dental floss. Conventional dental floss holder is generally classified to two types: one is spooling type and the other one is Y-shaped type; dental floss of the preceding type is reeled in a spool, when use, users have to draw the floss and tighten the floss up to scale teeth; in this way to clean teeth particularly requires cleanness of hands, or oral hygiene may be affected; besides rear molar teeth are difficult to clean in this way since manipulation angles.

As to the Y-shaped dental floss holder, dental floss of the Y-shaped holder is being fixed on a gap of the Y-shaped holder, when use, users can put the gap of the Y-shaped holder into a mouth without using the users' finger inside the mouth; therefore, the finger will not touch floss directly. However, rear molar teeth are still hard to be cleaned due to the manipulation angles of using the Y-shaped dental floss holder. Furthermore, the Y-shaped dental floss holder is usually thrown away after cleaning, which may cause garbage pollution and waste resources; so, aforementioned two types of dental floss holder need to be improved.

### SUMMARY OF THE INVENTION

Accordingly, an object of the present invention is to provide a dental floss holder for easily manipulating, replacing dental floss and repeatedly use.

Further object of the present invention is to provide a dental floss holder, which enables users to manipulate without putting the users' finger into the mouth and can clean rear molar teeth to keep well oral hygiene.

To achieve the above-mentioned objects, a dental floss holder includes a housing, a housing, a handle, a spool member, a position mechanism and a scraping member. The housing includes a fist case and a second case both being engagable with each other, wherein the fist case has an accommodation for accommodating the spool member. The handle communicates with the first case and is cooperatively defined by integrally extending from the first and second case, the handle having a penetrate hole located at one end thereof. A user can draw out the floss through the penetrate hole to a desired length and can manipulate the handle together with the floss for dental cleaning without putting the user's finger to the mouth. After finishing dental cleaning, the used floss can be cut by a cutter disposed on the bottom of the handle. Furthermore, a protection cover is jacketed on the handle in order to protect the dental floss holder and avoid being dirty.

### BRIEF DESCRIPTION OF THE DRAWINGS

FIG. 1 is an exploded perspective view of a dental floss holder of the present invention;

FIG. 2 is an assembled view of FIG. 1;

FIG. 3 is a perspective bottom view of FIG. 2 without a protection cover;

FIG. 4 is a perspective view of FIG. 2 in which the protection cover, a second extension portion and a second case are taken away; and

FIG. 5 is a perspective and transverse cross-sectional view of FIG. 2 without the protection cover.

### DESCRIPTION OF THE PREFERRED EMBODIMENTS

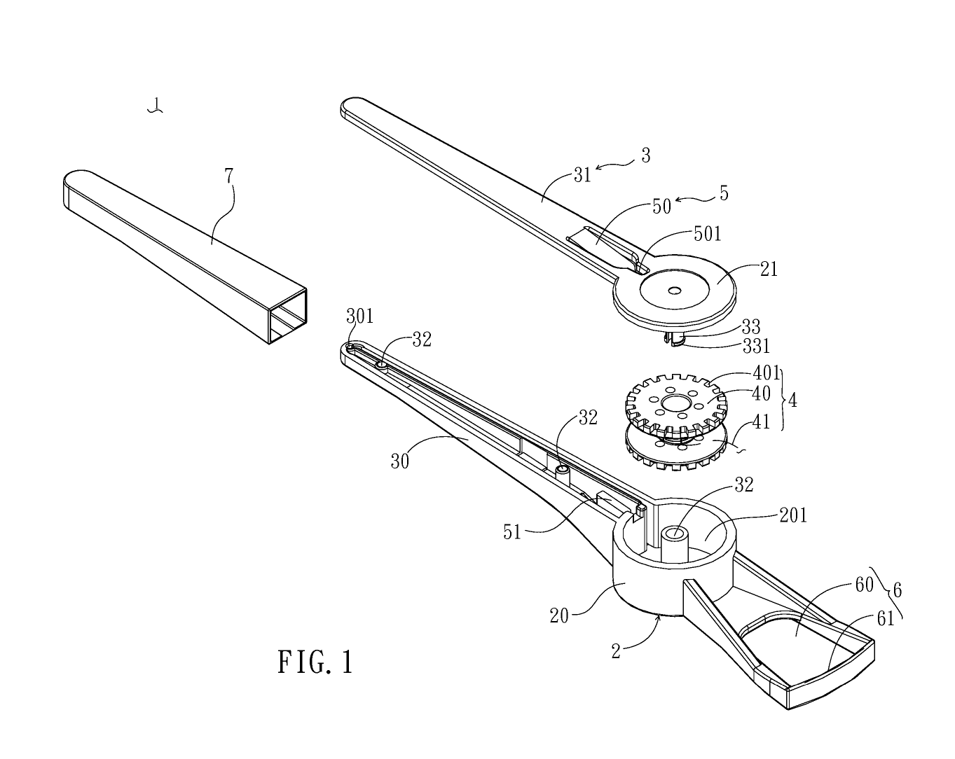

With reference to FIG. 1, a dental floss holder 1 includes: a housing 2, a handle 3, a spool member 4, a position mechanism 5 and a scraping member 6. The housing 2 includes a first case 20 and a second case 21 both being engagable with each other, wherein the first case 20 has an accommodation 201 for accommodating a spool 40 (described below).

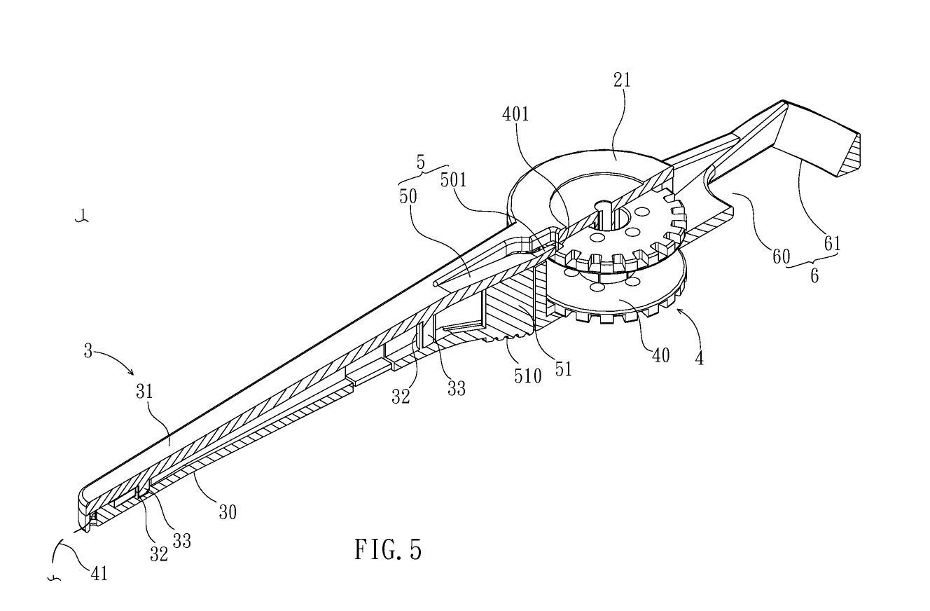

The handle 3 communicates with the first case 20 and is cooperatively defined by integrally extending from the first and second case 20, 21. The handle 3 includes a first extension portion 30 and a second extension portion 31, wherein the first extension portion 30 has a penetrate hole 301 located at one end thereof. The penetrate hole 301 is opposite to the first case 20 and is used for insertion of a roll of dental floss 41 (described below). Further referring to FIG. 5, the first case 20 and the first extension portion 30 have three hollow shafts 32 disposed thereon, wherein one of the hollow shafts 32 is disposed in the center of the accommodation 201 for supporting the spool 40. The second case 21 and the second extension portion 31 have a plurality of fixing pegs 33 being correspondingly mounted to the hollow shafts 32; particularly, one of the fixing pegs is corresponding to the hollow shaft 32 disposed in the accommodation 201. The corresponding fixing peg is of fork-shaped and has a flange part 331 (shown in FIG. 1) formed on one end thereof for engaging with the corresponding hollow shaft 32 with fasten-fit engagement. The other fixing pegs 33 respectively have a jam-fit engagement with the other hollow shafts 32.

The spool member 4 is pivotally mounted in the accommodation 201, the spool member 4 comprising a spool 40 and a roll of dental floss 41, wherein the spool has a plurality of position recesses 401 formed on peripheral sides thereof and are evenly spaced apart with each other. One end of the floss 41 (shown as broken line) is through the penetrate hole 301 of the handle 3.

The position mechanism 5 is disposed between the handle 3 and the accommodation 201, the position mechanism 5 having a clogging member 50 and a release bar 51. The clogging member 50 is integrally formed on the second extension portion 31 and is depressible, the clogging member 50 having a tab 501 located at one end thereof. The tab 501 is engagable with the position recess 401 of the spool 40. The release bar 51 is integrally formed on the first extension portion 30 and is depressible. The release bar 51 further has a rough face 510 formed on the outer side thereof for providing friction against a user's finger (not shown) to facilitate manipulation. By depressing the rough face 510 of the release bar 51 against the clogging member 50, the tab 501 of the clogging member 50 is disengaged from the position recess 401 and therefore releases an engagement between the tab 501 and the position recess 401. Furthermore, a cutter 81 is disposed on the bottom of the first extension portion 30 for cutting away the used floss 41.

Moreover, a scraping member 6 is integrally formed on a side of the first case 20 opposite to the first extension portion 30, the scraping member 6 including a hollow interior 60 and a curette 61. The curette 61 is used for cleaning tongue-coating and further keep dental hygiene. In addition a protection cover 7 is jacketed on the handle 3 of the dental floss holder 1 for protecting the handle 3 and avoiding the handle 3 and the floss 41 being exposed to unclean environment.

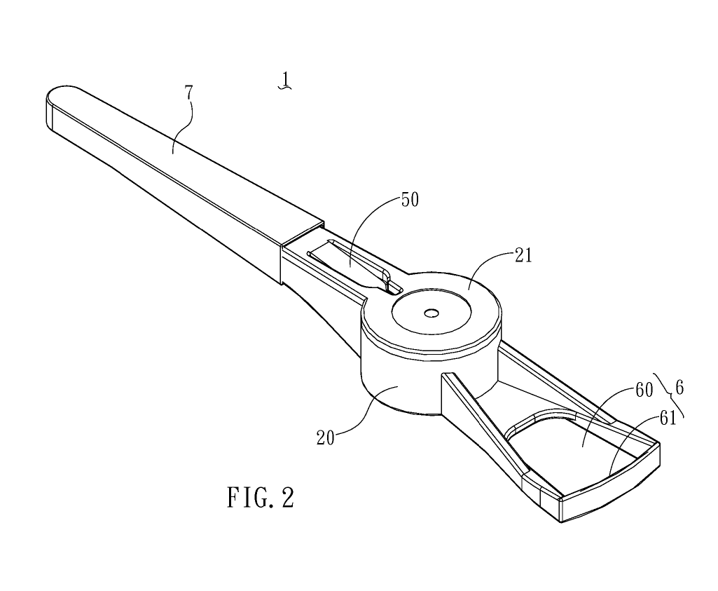

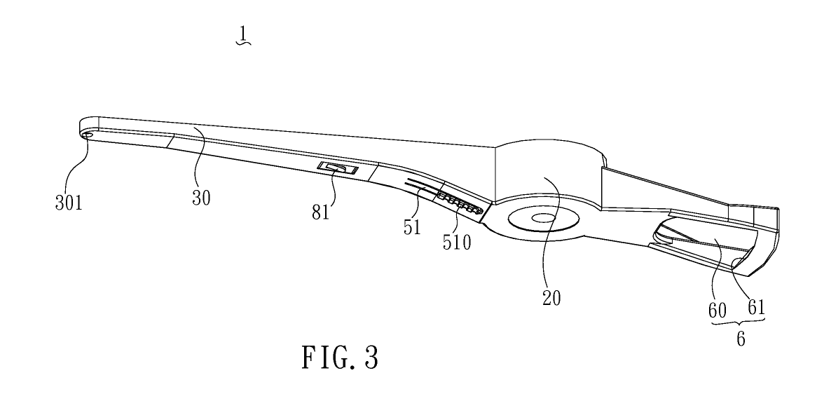

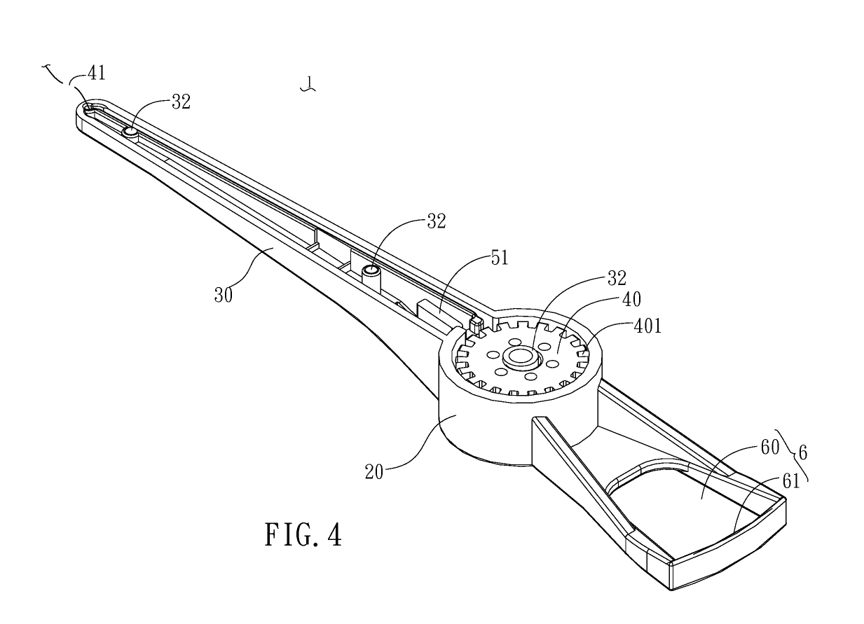

Referring to FIGS. 1 to 5, the present dental floss holder 1 in assembly, first, mount the spool 4 with the roll of dental floss 41 on the hollow shaft 32 in the accommodation 201, and draw out one end of the floss 41 along the handle 3 and through the penetrate hole 301, then assemble the second case 21 and the second extension portion 31 with the first case 20 and the first extension portion 30 by means of the fasten-fit and jam-fit engagement between the hollow shafts 32 and the fixing pegs 33 (shown in FIG. 5), whereby the tab 501 of the clogging member 50 engages with the position recess 401 of the spool 40.

In use, depress the rough face 510 of the release bar 51 against the clogging member 50 to disengage the tab 501 from the position recess 401, and then draw out the floss 41 to a proper length, after the length of the floss 41 is determined, stop depressing the release bar 51, so the tab 501 returns engagement position against the position recess 401, and then put the handle 3 with the exposed floss 41 to the user's mouth for dental cleaning. The extending handle 3 has been found to greatly facilitate use of the device in flossing front teeth as well as rear teeth, particularly without putting the user's finger into the mouth. After finishing dental cleaning, the used floss 41 can be cut away by the cutter 81, and the protection cover 7 is jacketed on the handle 3 to protect the dental floss holder and avoid being dirty.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A dental floss holder, comprising:
a housing including a first case and a second case being engagable with each other, the fist case having an accommodation;
a handle communicating with the first case and having a penetrate hole disposed on one end thereof;
a spool member pivotally mounted in the accommodation, the spool member comprising a spool and a roll of dental floss wherein one end of the floss being through the penetrate hole of the handle; and
a position mechanism disposed between the handle and the accommodation, the position mechanism having a clogging member being engagable with the spool, and a release bar for disengaging the clogging member from the spool.

2. The dental floss holder according to claim 1, the handle is cooperatively defined by integrally extending from the first and second case and includes a first extension portion and a second extension portion, wherein the penetrate hole is located at one end of the first extension portion opposite to the first case.

3. The dental floss holder according to claim 2, wherein a plurality of hollow shafts are disposed in the first case and the first extension portion, one of the hollow shafts disposed in the center of the accommodation for supporting the spool, and a plurality of fixing pegs are disposed on the second case and the second extension portion and mounted to the hollow shafts.

4. The dental floss holder according to claim 3, wherein the hollow shaft in the center of the accommodation has a fasten-fit engagement with the corresponding fixing peg, and the other hollow shafts respectively have a jam-fit engagement with the fixing pegs.

5. The dental floss holder according to claim 4, wherein one of the fixing pegs corresponding to the hollow shaft of the accommodation is of fork-shaped and has a flange part formed on one end thereof for engaging with the hollow shaft.

6. The dental floss holder according to claim 1, wherein a plurality of position recesses are formed on peripheral sides of the spool and are evenly spaced apart with each other.

7. The dental floss holder according to claim 6, wherein the clogging member is integrally formed on the second extension portion and is depressible, the clogging member having a tab located at one end thereof, the tab being engagable with the position recess of the spool.

8. The dental floss holder according to claim 7, wherein the release bar is integrally formed on the first extension portion and is depressible against the clogging member to release an engagement between the tab and the position recess.

9. The dental floss holder according to claim 8, wherein a rough face is formed on the outer side of the release bar for providing friction against a user's finger to facilitate manipulation.

10. The dental floss holder according to claim 1, further comprises a scraping member integrally formed on a side of the first case opposite to the first extension portion, the scraping member including a curette and a hollow interior.

11. The dental floss holder according to claim 1, further comprises a protection cover used to be jacketed on the handle.

12. The dental floss holder according to claim 1, further comprises a cutter disposed on the bottom of the first extension portion.
